(19) United States
(12) Patent Application Publication
(10) Pub. No.: US 2018/0155875 A1
(43) Pub. Date: Jun. 7, 2018

(54) PROCESS FOR THE PRODUCTION OF PAPER OR PAPERBOARD, PAPER OR PAPERBOARD PRODUCT OBTAINED AND USES THEREOF

(71) Applicant: INNVENTIA AB, Stockholm (SE)

(72) Inventors: Mikael Ankerfors, Upplands Väsby (SE); Tom Lindström, Sollentuna (SE); Gunborg Glad-Nordmark, Sollentuna (SE)

(21) Appl. No.: 15/575,410

(22) PCT Filed: May 19, 2016
(86) PCT No.: PCT/SE2016/050460

§ 371 Date: Nov. 20, 2017

(30) Foreign Application Priority Data
May 22, 2015 (SE) 1550654-6

(51) Int. Cl. D21H 17/26; D21H 21/22; D21J 1/00; D21H 27/00; D21H 27/08; B32B 29/00

(52) U.S. Cl. CPC D21H 17/26; D21H 21/22; B32B 29/002; D21H 27/002; D21H 27/08; D21J 1/00

(57) ABSTRACT

Process for the production of a cured pulp product suitable for use in the production of paper, paperboard, tissue paper, filter paper or fluff pulp, comprising the steps of attaching an anionic or amphoteric carboxymethyl cellulose (CMC) to cellulosic fibres in acidic conditions or in the presence of divalent metal ions. Aluminium ions or divalent ions are then added to the slurry to a total molar concentration of from 0.0001 M to 0.5 M in the first pulp slurry. The first pulp slurry is then dewatered and cured in acidic conditions and a cured pulp product is provided. The cured pulp product is subsequently used in a paper making process to provide a paper-based product, whereby higher bulk is provided for the final paper-based product. Alternatively, the curing step is omitted and instead aluminium ions are added to the first pulp slurry and the pulp is directly used in a paper making process.

### TECHNICAL FIELD

The present invention relates to a process for the production of a cured pulp product suitable for use in the production of paper, paperboard, tissue paper or fluff pulp, to a cured pulp product obtained by the process, to a use of the cured pulp product for the production of paper or paperboard, fluff pulp, filter paper, or tissue, to a process for the production of paper or paperboard and to a use of the produced paper or paperboard as a packaging material.

### BACKGROUND

Packaging materials of paperboard have been used for a long time for packaging of different goods to provide mechanical and/or chemical protection for the goods. There is a growing demand for light weight packaging materials, which have good mechanical strength to ensure sufficient protection of the goods.

Bulking fibres have historically been used and developed in the field of tissue manufacture, where soft structures have a particular consumer value. Bulking fibres can also be used for the manufacture of fluff pulps. Typical treatments involve cross-linking agents, such as citric acid/catalysts and/or curling treatments. Also, some development work to lower the density of board materials has been made in connection with cellulosic fibre board materials used as heat insulating, sound insulating, or cushioning materials. However, such materials do not have the same requirements for mechanical properties as packaging materials. For example, document JP S54-138060 discloses a method for manufacturing low-density flame-retardant cellulosic fibreboard for use as heat or sound insulation material or as a cushioning material. In the method a wood pulp is first impregnated with an aqueous solution of ammonium phosphate to render the board material incombustible. The wood pulp is then dried and heated to 130-170° C. to obtain cellulose phosphate. The cellulose phosphate is then re-slushed to a concentration of 2.5 wt-% and the cellulose phosphate is beaten in water. The pH is then adjusted to pH 2.7 to 6.5 by using a multivalent metal salt, such as aluminium sulphate, in an amount of about 20-30% by weight of water. The slurry is then formed to a fibre board, dewatered and dried at a temperature of 100-125° C. for 1 to 3 hours. The metal group is attached to the phosphate group after curing, whereby the fibre bundle can get an increased volume and thus the board may get a low density. However, the metal salt is added to the obtained cellulose phosphate after the cured phosphate-impregnated web is re-slushed and before the dewatering of the final board material web. Ammonium phosphate is used as a flame retardant and therefore, there is a need to find materials that are suitable for use in packaging materials and which are environmentally friendly and safe to use in working environments.

Thus, even though there are known methods to increase bulk of fibres, there is a need to provide a process suitable for use in connection with the production of paper and packaging board.

### SUMMARY OF THE INVENTION

It is an object of the present invention to provide a process for the production of a cured pulp product that can be used for the production of paper or paperboard with low density and high bulk.

It is a further object of the present invention to provide a low density paper or paperboard product suitable for use as packaging material.

It is also an object of the present invention to minimize problems identified in connection with the production of prior art low density materials.

According to the present invention, cellulosic fibres are treated to obtain light-weighting of a cellulosic material. The treatment provides “bulking fibres”, which can be used to make bulky paper and paperboard materials while the bending stiffness can be maintained with a lower basis weight. Alternatively, the bulking fibres may be used to increase the bending stiffness with a maintained basis weight. The bulking fibres can also be used in the manufacture of tissue paper, filter paper, and fluff pulp, which can be used for example in absorbent products.

Thus, it is an object with the present invention to provide a process for the production of a cured pulp product through which bulking fibres can be obtained.

It is also an object of the present invention to provide a treatment of pulp, which results in a significant reduction of the water retention value, which is beneficial for the dewatering and pressing efficiencies during paper/paperboard making, resulting in a higher dry content after the press-section. Thereby, the need for drying energy in the drying process during paper/paperboard manufacture can be decreased. Hence, if the treatment step according to the invention takes place in a pulp mill, and the pulp is used in a non-integrated paper/board mill, the resource efficiency in the paper or paperboard mill will be much higher both in terms of material and energy efficiency.

Further objects and advantages will be apparent from the following disclosure of the present invention.

The objects above are attained by a process according to the first embodiment of the invention relating to a process for the production of a cured pulp product suitable for use in the production of paper, paperboard, tissue paper, filter paper, or fluff pulp, comprising the steps of:
i) providing a first aqueous pulp slurry comprising cellulosic fibres and having a pulp consistency of from 0.1 to 40% by weight, calculated as dry weight of the cellulosic fibres in the first pulp slurry;
ii) adjusting the pH of the first pulp slurry to a pH of from pH 1.5 to pH 4.5, or alternatively treating the first pulp slurry with a metal salt containing divalent metal ions selected from Zn²⁺, Mg²⁺, Ca²⁺ or mixtures thereof, to a total molar metal ion concentration of from 0.0001 M to 0.5 M in the first pulp slurry;
iii) attaching an anionic or an amphoteric carboxymethyl cellulose (CMC) or a derivative thereof to the cellulosic fibres in the first pulp slurry by treating the pulp with the CMC at a temperature of at least 50° C.;
iv) adding to the first pulp slurry a metal salt comprising Al³⁺ ion to a total molar concentration of aluminium ions of from 0.0001 M to 0.5 M in the first pulp slurry, or alternatively controlling the concentration of the divalent metal ions in the pulp slurry and adjusting the total molar concentration of the divalent metal ions to a range of from 0.0001 M to 0.5 M in the first pulp slurry, if the total molar concentration is not within the range of from 0.0001 M to 0.5 M in the first pulp slurry;
v) controlling the pH and adjusting the pH of the first pulp slurry to a pH of from pH 3.0 to pH 6.0 if the pH is not within the range of from 3.0 to 6.0;
vi) dewatering and curing the first pulp slurry at a temperature of at least 60° C. and thus provide a cured pulp product.

This process is also herein below referred to as a “dry” process since it includes a step of curing. In the process, when the fibres are treated with multivalent metal ions (cations) in acidic conditions in steps iv) and v), the hornification of the fibres increases and thereby stiffer fibres are obtained.

Hornification refers to an irreversible internal bonding in lignocellulosic fibre materials that takes place upon water removal or drying/curing. The hornified fibres do not swell to the same extent as the non-hornified fibres (i.e. they cannot take up as much water) and this difference can e.g. be measured as a decrease in water retention value. The irreversible bonding also leads to a stiffening of the polymer structure in the fibres and papers made from stiffer fibres are bulkier. Thus, the process according to the first aspect of the invention provides bulking fibres and leads to webs that are easy to dewater during a papermaking process.

By the attachment of CMC to the fibres the charge density, or the anionic charge density of the fibres, can be increased, which is beneficial in the following paper making process.

It should be noted that in the present application, when an interval from a first value to a second value is described, it is meant that any individual value within the claimed interval may be chosen, including the end values. For example, regarding the pulp consistency in the interval “of from 0.1 to 40% by weight”, it is meant that any value within the interval, such as 1%, 10%, or 40% may be chosen for the pulp consistency. Further as an example and in a corresponding way the pH may be chosen to be any pH value within the claimed interval of from 3.0 to 6.0 and can be for example pH 3.0, 3.5, pH 5.0, or pH 6.0.

According to one embodiment the first pulp slurry is dewatered and subsequently or concurrently cured by means of flash drying. Flash drying is suitably performed at a temperature that is higher than for example when drying by means of heated cylinders, and the temperature can be from 100 to 300° C., depending on the heat sensitivity of the first pulp slurry. Also the curing time is normally shorter when flash drying is used. By flash drying a further bulking effect, i.e. a higher bulk with lower density, may be obtained. Thus, in the step vi) the first pulp slurry can be cured by means of flash drying at a temperature from 100° C. to 300° C., preferably from 150° C. to 270° C. and most preferably from 180° C. to 240° C. The curing time can be less than 5 minutes, preferably less than one minute. Therefore, essentially shorter curing time may be obtained compared to traditional curing methods.

According to another embodiment, in the step vi) the first pulp slurry is cured at a temperature from 60 to 150° C. by means of heated air or steam, wherein the heated air or steam is lead directly to heat the first pulp slurry or indirectly to heat the first pulp slurry, for example heated cylinders. The higher the temperature during the curing is, the higher will the bulk be, and thus the bulking effect. By using these curing methods in the step vi), it is possible to provide the cured pulp product in the form of a web, i.e. a cured web. The web may then be collected and rolled up to web rolls and then provided to a papermaking mill. The process may then further comprise a step vii) comprising cutting the cured web into sheets and stacking the sheets to provide bales of pulp. The bales of pulp are easy to transport to a paper mill and can be readily used in a papermaking process.

In the process in the step vi) the first pulp slurry is preferably cured until a moisture content of below 50%, suitably below 30%, and preferably below 15% is obtained. The moisture content may be 0%, but usually the moisture content is from about 1 to 10%. The more the web is cured, the greater will the density decrease of the material be and thus the greater the bulking effect obtained.

The metal salt comprising the multivalent, i.e. divalent or trivalent, metal ion is preferably added to the first pulp slurry in the step iv) at a molar concentration of from 0.0001 M to 0.05 M which is sufficient to obtain bulking effect while the risk for deteriorating the quality of the fibres is minimized. According to one preferable variant the multivalent metal ion added in the step iv) is Al³⁺, which is commonly known in papermaking.

The pulp consistency of the first aqueous pulp slurry is of from 0.5% to 30%, preferably of from 1% to 20%, calculated as dry weight of the cellulosic fibres in the first pulp slurry. Preferably, the pulp concentration is as high as possible, whereby a more effective ion exchange can be achieved, and thus the concentration of the added metal salt can be kept at a low level.

The CMC can be amphoteric and have a cationic molar substitution degree of from 0.00001 and 0.4 and an anionic molar substitution degree of from 0.3 to 1.2, and wherein a net charge of the CMC is anionic. By using amphoteric CMC, the amount of the CMC used can be decreased and still a sufficient amount can be attached to the fibres. However, the CMC may also be anionic and have an anionic molar substitution degree of from 0.3 to 1.2. Generally, anionic CMC is cheaper, and even though larger amount of anionic CMC is needed for attaching an equal amount of CMC to fibres than amphoteric CMC, a more economical process can be provided if anionic CMC is used. The amount of the anionic or amphoteric CMC attached during the treatment is suitable of from 1 mg/g to 100 mg/g, based on the weight of the cellulosic fibres in the first pulp slurry.

The first aqueous pulp slurry may comprise a pulp selected from a kraft, soda, sulfite, mechanical, thermomechanical, semi-chemical or chemi-thermomechanical pulp, or mixtures thereof, and will be explained more in detail below.

The present invention also relates to a cured pulp product obtained by the process.

The cured pulp product may then be used in several applications, such as in the production of paper or paperboard, tissue paper, filter paper, or fluff pulp. According to one aspect, the invention further relates to a process for the production of paper or paperboard comprising the steps of:
a. providing a cured pulp product as defined above to a paper making process;
b. re-slushing the cured pulp product to provide a second pulp slurry;
c. dewatering the second pulp slurry to provide a web of paper or paperboard;
d. drying the web of paper or paperboard to provide a dried web of paper or paperboard.

The processes for the production of paper or paperboard described above may further comprise adding a dry strength aid or a wet strength resin to the first pulp slurry, suitably for example between the steps b. and c. In this way the strength of the paper or paperboard can be improved, while still maintaining an improved bulking effect.

According to a second embodiment of the invention, paper or paperboard may be produced in an integrated paper mill, i.e. a mill that comprises both a pulp mill and a paper mill without drying the pulp before the paper/board machine. In an integrated paper mill it has been found that it is not necessary to cure the pulp before a paper or paperboard making process. Thus, the present invention also relates to a process for the production of paper or paperboard suitable for use as a packaging board. The definition paper also includes e.g. tissue paper and filter paper. The process according to a further embodiment comprises the steps of:
I. providing a first aqueous pulp slurry comprising cellulosic fibres and having a pulp consistency of from 0.1 to 40% by weight, calculated as dry weight of the cellulosic fibres in the first pulp slurry;
II. adjusting the pH of the first pulp slurry to a range between pH 1.5 to pH 4.5, or alternatively treating the first pulp slurry with a metal salt containing divalent metal ions selected from Zn²⁺, Mg²⁺, Ca²⁺ or mixtures thereof, to a total molar concentration of the metal ions of from 0.0001 to 0.5 M in the first pulp slurry;
III. attaching an anionic or amphoteric carboxymethyl cellulose (CMC) or a derivative thereof to the cellulosic fibres in the first pulp slurry by treating the pulp with the CMC at a temperature of at least 50° C.;
IV. adding to the first pulp slurry a metal salt comprising an Al³⁺ metal ion to a molar concentration of from 0.0001 M to 0.5 M in the first pulp slurry, whereby an ion-exchange occurs;
V. providing the first pulp slurry to a papermaking process and thus provide a second pulp slurry;
VI. dewatering the second pulp slurry to provide a web of paper or paperboard;
VII. drying the web of paper or paperboard to provide a dried web of paper or paperboard.

This process is also referred to as a “wet” process, since the curing step before the paper making process is omitted.

In the process, in the step IV) it has been found that aluminium containing metal salt is suitable for use. Without binding the applicant to any specific theory, one possible explanation is that by the presence of aluminium ions it is possible to increase the friction between the fibres on the surface. Therefore, it is possible to maintain the network of the fibres during drying and thus it is possible to provide higher bulk. Thus, according to this embodiment, the addition of aluminium ion Al³⁺ is essential, while the curing step before the papermaking process is not essential. Thus, in this way pulp slurry with a high bulk can be provided for the use in an integrated mill.

In the dry and wet processes described above, the first aqueous pulp slurry may comprise a chemical pulp selected from a sulfate, kraft, soda, or sulfite pulp, a mechanical pulp, a thermomechanical pulp, a semi-chemical pulp (e.g., a neutral sulphite semi-chemical pulp; NSSC), or a chemi-thermomechanical pulp, or mixtures thereof. According to one variant, the first pulp slurry comprises kraft pulp, whereby a high quality raw material for the process can be provided.

The pulp consistency of the first aqueous pulp slurry is suitably from 0.5% to 30% and preferably from 1% to 20%. Preferably, the pulp concentration is as high as possible, whereby a more effective ion exchange can be achieved, and thus the concentration of the added metal salt can be kept at a low level.

The CMC can be anionic or amphoteric. According to one embodiment, the CMC is amphoteric and has a cationic molar substitution degree between 0.00001 and 0.4, and an anionic molar substitution degree from 0.3 to 1.2.

According to another embodiment, the CMC is anionic and has an anionic molar substitution degree of from 0.3 to 1.2. Anionic CMC is cheaper to produce and thus a more economical process can be provided if anionic CMC is used.

The amount of CMC used during the treatment can be from 1 to 100 mg/g, based on the dry weight of the cellulosic fibres in the first pulp slurry. By using the specific amount, all CMC can be attached to the cellulosic fibres. Thus, the attached amount of CMC can be from 1 to 100 mg/g.

Further in the wet process described above, in the step iv) a metal salt comprising an Al³⁺ metal ion can be added to the first pulp slurry to a total molar concentration of aluminium ions of from 0.0001 M to 0.05 M, whereby ion-exchange occurs. The concentration of the aluminium salt in the specific range is sufficient to obtain a bulking effect on different bulking levels.

The processes for the production of paper or paperboard described above may further comprise adding a dry strength aid or a wet strength resin to the first pulp slurry, suitably for example between the steps V. and VI. In this way the strength of the paper or paperboard can be improved, while still maintaining an improved bulking effect.

Further, the present invention relates to a paper or paperboard obtained by the processes as described above. The paper or paperboard product may have a structural density of from 150 to 600 kg/m³ according to SCAN-P-88:01, whereby a low density product can be provided for packaging purposes. Preferably, the paper or paperboard product is used as a packaging material, and more preferably as a middle layer in a paper board, whereby the bulk of the board can be increased.

It has also been found that the cured pulp product obtained according to the first embodiment of the process, the “dry” process described process in steps i)-vi) can also be used for the production of a fluff pulp or filter or tissue paper. The fluff pulp may be further used for example in absorbent products.

Further features and advantages of the present invention are described in the following detailed description and examples with reference to the appended drawings.

### BRIEF DESCRIPTION OF THE DRAWINGS

FIG. 1 is a flow chart which shows the main steps of the present process according to a first embodiment, “dry process”;

FIG. 2 is a flow chart which shows the main steps of the present process according to a second embodiment, “wet process”;

FIG. 3 shows a graph which illustrates effects on the water retention value of a pulp obtained from a process according to the first embodiment of the invention, the “dry process”, with attachment levels of 20 mg/g and 40 mg/g amphoteric CMC and drying the sheets at 120° C. for 2 h and re-slushing the pulp and forming sheets.

FIG. 4 shows a graph which illustrates effects on the sheet density of a pulp obtained from a process according to the first embodiment of the invention, the “dry process”, with attachment levels of 20 mg/g and 40 mg/g amphoteric CMC and drying the sheets at 120° C. for 2 hrs and re-slushing the pulp and forming sheets.

FIG. 5 shows a graph which illustrates the effect of curing temperature on water retention value when pulp is treated with 20 mg/g amphoteric CMC and the pulp is in its Al³⁺-form (0.005 M) and pH 3.5 and dried at 120° C. for 2 hrs (“dry process”).

FIG. 6 shows a graph which illustrates the effect of different metal ions on water retention value when pulp is treated with 20 mg/g anionic CMC and the pulp is in its Al³⁺-form (0.005 M) and pH 3.5 and the curing temperature at 120° C. for 2 hrs (“dry process”).

FIG. 7 shows a graph which illustrates the tensile index versus structural density of paper sheets pressed to different densities when the pulp was treated with 20 mg/g anionic CMC and the pulp is in its different ionic forms (Na⁺, Ca²⁺ and Al³⁺), “wet process”.

### DETAILED DESCRIPTION

There is a long-time felt need for lighter and stronger packaging materials. The inventors of the present invention have found an economical and efficient method to treat fibres in a process that increases the bulk of paper or paperboard materials and thus provides lighter packaging materials while the mechanical properties of the material can be maintained sufficiently by using chemical additives for packaging purposes.

Below, general descriptions for some of the used definitions in this application are given.

Paper and paperboard relate to a materials made from pulp comprising cellulosic fibres. Paper and paperboard are manufactured from cellulosic fibres by dewatering fibres on a wire, then pressing the moist fibre web or webs together and then drying the fibres into thin, flexible material. Paper is a single layer-product and can normally have a grammage or basis weight below 200 g/m². By paper is also meant e.g. printing paper, kraft paper, tissue paper or filter paper.

Paperboard may be a single layer product or it may be a multi-layer or multi-ply paperboard product comprising several layers containing pulp and thus fibres. Paperboard may for example comprise at least three layers, the layers being a top layer, middle layer and bottom layer, i.e. there are two surface layers. Multi-layer paperboard may comprise at least one middle layer but may contain more than one middle layer. Suitably the amount of middle layers is from 1-10, preferably from 1 to 5, and most preferably from 1 to 3. Each layer containing fibres is formed by suitably pumping an aqueous pulp from a respective head-box to a wire section of a paperboard machine. The wire section of the paperboard machine may comprise one or more wires. Suitably, the paperboard machine comprises as many wires as it contains head-boxes, but a multi-layered web can also be produced using a single head-box able to produce a multi-layered sheet, thus decreasing the number of necessary wires for dewatering. In case of multi-wire solutions, the individual layers are couched. The formed wet web is then mainly dewatered in a press section of a paperboard machine and finally dried in a drying section of a paperboard machine. Paperboard normally has a grammage exceeding 200 g/m², suitably over 220 g/m². However, the grammage of the multi-layer paperboard obtained by the process of the present invention may be as low as 120 g/m², but is preferably at least 160 g/m².

By tissue paper is meant a very thin or light weight paper often produced with a paper machine comprising a steam heated drying cylinder (yankee cylinder) or by through-air-drying (TAD) of the tissue paper. Tissue paper has often good absorbent capacity, for example from about 1 g liquid/1 g fibre, but may be more or less depending on the quality of the tissue paper.

Fluff pulp is pulp having absorbent properties. Fluff pulp is often based on a chemical pulp, preferably kraft pulp or a chemi-thermomechanical pulp (CTMP). Preferably, the raw material used comprises long fibres, and can be derived from soft wood material, such as spruce, pine, fir, larch, cedar, and hemlock.

Filter paper is a paper used for filter applications where a passing fluid is passed through the paper to capture for instance particles. The passing fluid may be a gas such as air or a liquid such as water. Fluff pulp is pulp having absorbent properties.

Cellulosic fibres are fibres originating from unbleached or bleached pulp comprising a pulp selected from a kraft, soda, sulfite, mechanical, a thermomechanical pulp (TMP), a semi-chemical pulp (e.g., neutral sulfite semi-chemical pulp; NSSC), recycled pulp or a chemi-thermomechanical pulp (CTMP). The raw material for the pulps can be based on softwood, hardwood, recycled fibres or non-wood fibres suitable for making paper or paperboard/cardboard. The softwood tree species can be for example, but are not limited to: spruce, pine, fir, larch, cedar, and hemlock. Examples of hardwood species from which pulp useful as a starting material in the present invention can be derived include, but are not limited to: birch, oak, poplar, beech, eucalyptus, acacia, maple, alder, aspen, gum trees and gmelina. Preferably, the raw material mainly comprises softwood. The raw material may comprise a mixture of different softwoods, e.g. pine and spruce. The raw material may also comprise a non-wood raw material, such as bamboo and bagasse. The raw material may also be a mixture of at least two of softwood, hardwood and/or non-woods.

By pulp consistency is meant dry content in an aqueous pulp slurry. That is, for example a consistency of 10% means that the weight of the dry matter is 10%, based on the total weight of the pulp slurry.

By curing is meant that a physical or chemical reaction occurs in the material in addition to evaporation of water. By drying is meant evaporation or draining away water or other liquids from a material.

Dewatering is a procedure by which water is removed from a wet pulp web. Dewatering can be performed mechanically during the web formation on a wire for example by means of vacuum or centrifugal forces. Dewatering may also be performed by means of mechanical forces, e.g. by means of pressing, e.g. in a pressing section of a paper machine. After dewatering on a wire and/or mechanical dewatering, the web can be forwarded to a drying section, in which the remaining water/moisture in the web is evaporated by means of heat, which is also called thermal dewatering. The drying section may be designed in different ways and can comprise e.g. multi-cylinder dryer, yankee cylinder drying, through-air drying or flash drying equipment.

By moisture content is meant the water content of the material expressed in weight %, and based on the total weight of the material.

By water retention value is meant a test value that provides an indication of fibres' ability to take up water and swell, and is in this application measured by means of a standard method SCAN-C 62:00 unless otherwise stated.

In this application, the definition of re-slushing is used equally with re-pulping and re-slurrying and means that a cured pulp is re-suspended in water to provide an aqueous suspension containing cellulosic fibres.

In the present application by bulking fibres are meant fibres that after treatment obtain a more bulky material structure than fibres that have not been treated. By bulking effect is meant an effect which decreases the density of a material compared to a material that has not been treated.

By molar concentration is meant the concentration or the amount of a substance (mole) in one dm³ or litre of a mixture, e.g. molar concentration of metal ions equals to moles of the ions in one litre of an aqueous solution/suspension containing water and a metal salt.

By “degree of substitution” or “DS”, is meant the number of substituted ring sites of beta-anhydroglucose rings of the carboxymethyl cellulose, CMC. Since there are three hydroxyl groups on each anhydroglucose ring of the cellulose that are available for substitution, the maximum value of DS is 3.0.

The carboxymethylcellulose (CMC) used in the present invention is anionic or amphoteric. It is essential that the CMC is charged, however, the reaction agent to render the CMC charged needs not be of any specific kind. The amphoteric CMC has an anionic net charge. Any anionic or amphoteric CMC suitable for use in papermaking industry could be used in the embodiments of the present process. Anionic or amphoteric CMC and reaction agents to render the CMC charged are known to the skilled person in the art and examples, which should not be considered to be limiting, of the CMC usable in the present invention are described below.

The anionic carboxymethyl cellulose (CMC) useful in the process of the present invention has a degree of substitution of up to the theoretical limit of 3.0, but preferably from about 0.30 to 1.20 carboxymethyl substituents per anhydroglucose unit of cellulose.

The CMC usable in the present invention has a net anionic charge, but may comprise also cationic groups whereby the CMC is amphoteric. An amphoteric CMC can have a cationic degree of substitution in the range of from 0.00001 to 1.0, preferably from 0.00001 to 0.4. The amphoteric CMC can also have an anionic degree substitution in the range of from 0.3 to about 1.20.

Examples of suitable anionic groups include carboxylate, e.g. carboxyalkyl, sulphonate, e.g. sulphoalkyl, phosphate and phosphonate groups in which the alkyl group can be methyl, ethyl propyl and mixtures thereof. The CMC suitably contains an anionic group comprising a carboxylate group, e.g. a carboxyalkyl group. The counter-ion of the anionic group can be an alkali metal or alkaline earth metal ion, such as sodium.

Examples of suitable cationic groups of CMC can include salts of amines, suitably salts of secondary ammonium groups, tertiary amines, and quaternary ammonium groups. The substituents attached to the nitrogen atom of secondary ammonium groups, amines and quaternary ammonium groups can be the same or different and can be selected from e.g. alkyl, cycloalkyl, and alkoxyalkyl groups. The substituents can comprise from 1 to about 24 carbon atoms, independently of each other. The nitrogen of the cationic group can be attached to the CMC directly or by means of a linking chain of atoms which can comprise carbon and hydrogen atoms, and optionally oxygen and/or nitrogen atoms. For example the linking chain of atoms can be an alkylene group with from 2 to 18 carbon atoms, and may contain one or more 0 or N atoms. Examples of CMC containing cationic groups include those obtained by reacting CMC with a quaternization agent selected from 2,3-(epoxypropyl) trimethylammonium chloride, (4-chlorobutene-2)-trimethylammonium chloride, 2-diethylaminoethyl chloride and mixtures thereof.

The cationic groups are suitably quaternary ammonium groups and then the cationic degree of substitution referred to herein is the same as the degree of substitution of quaternary ammonium groups.

The anionic and/or amphoteric CMC usually has an average molecular weight which is at least 20 000 Dalton, preferably at least 50 000 Dalton, and up to about 1 000 000 Dalton, preferably up to about 500 000 Dalton.

The amount of CMC added to the pulp slurry during the treatment can be from 5 to 100 mg/g fibres, based on the weight of the cellulosic fibres in the first pulp slurry. Suitably, the amount is from about 10 to 30 mg/g, based on the weight of the cellulosic fibres in the first pulp slurry. All CMC can be attached to the fibres, and therefore the attached amount of CMC corresponds to the added amount, e.g. from 5 to 100 mg/g fibres.

Process Description

As already mentioned above, it is desirable to produce packaging materials with a higher bulk. However, despite prior art solutions there is still a need to improve processes to produce bulky paper, such as tissue paper or filter paper, paperboard, or fluff pulp in an economical and efficient way. It is also desirable that existing process equipment can be used to produce paper or paperboard. It is thus essential that the characteristics of the treated pulp material or product used in paper mills do not negatively affect the papermaking process. It is desirable that the paperboard production in the existing paper mills can be run with as few modifications as possible.

According to the first embodiment of the present process, which is also in this context referred to as a “dry process”, it is possible to provide a cured pulp product in the form of a web of pulp, bales of pulp or flakes of pulp for a further production of paper or paperboard in a paper mill or factory. The flakes may be in the form of a free flowing material or the flakes may be gathered to bales. In the process the pulp is treated with multivalent metal ions, such as aluminium, calcium, magnesium or zinc ions (cations) so as to obtain bulking fibres.

When the pulp is cured, the physical/chemical reactions that occur during curing render the internal structure of the pulp material stabilized before further processing of the cured pulp product. Therefore, the fibres show less swelling when re-slushed during paper or paperboard manufacture than fibres that are not treated. Thus, for example significant lowering of the water retention value can be obtained when the cured pulp product of the invention is used compared to a pulp material that is not cured. This is beneficial for the pressing efficiency. Thereby, a higher dry content after the press section in a paper machine may be obtained, which is especially beneficial in paper mills having limited drying capacity.

When the pulp is provided in an integrated paper mill, according to the second embodiment of the present invention the pulp is not cured before it is provided to the paper or paperboard making process. By the treatment with aluminium salts during the paper or paperboard making process it is possible to increase the bulk of the obtained paper or paperboard. Without binding the applicant to any specific theory, this may be caused by the increased friction between fibres on the surface of the pulp product and therefore, it is possible to maintain the network of the fibres during curing and thus it is possible to provide a structure with higher bulk.

The processes according to the embodiments of the present invention have been found to be efficient to produce paper-based products having a higher bulk than paper-based products produced from non-treated pulps. Also, during the paper making process the pulp can be mechanically pressed to higher solids content and therefore drying energy is saved during the paper or paperboard making processes. As mentioned above, a further advantage is that that the productivity of drying-limited paper/board machines can be enhanced.

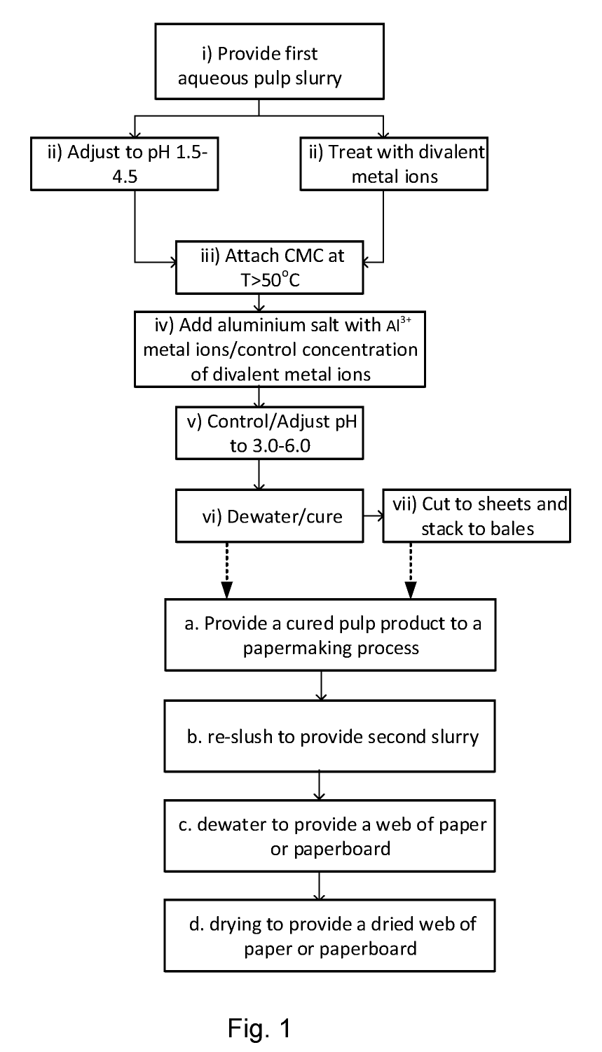

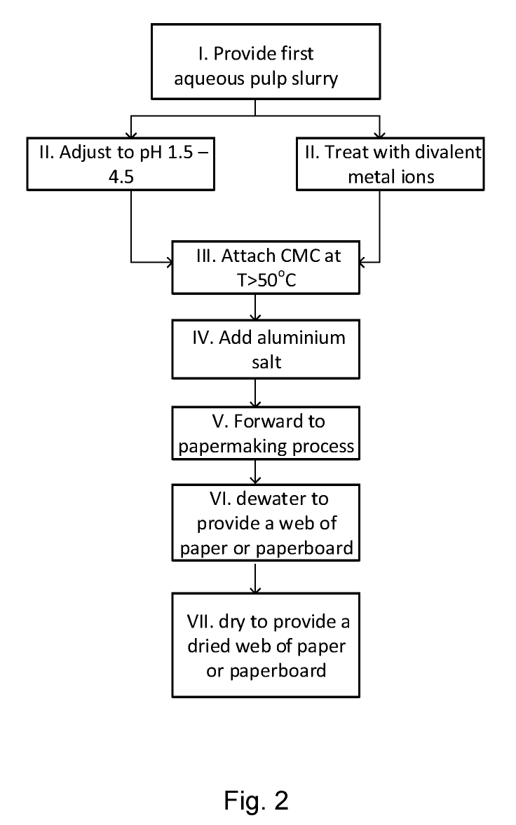

A first embodiment of the present process is illustrated in FIG. 1 in which steps of the process are illustrated in a flow chart. The first embodiment of the present process is also referred to as a “dry process”. A second embodiment of the present process is illustrated in FIG. 2 in which steps of the process are illustrated in a flow chart. The second embodiment of the present process is also referred to as a “wet process”. By the first embodiment of the present process a cured pulp product suitable for use for the production of paper, paperboard, tissue or filter paper or fluff pulp can be provided. Fluff pulps are commonly used in for example absorbent products.

By the second embodiment of the present process it is possible to provide a treated pulp usable directly in a papermaking process, e.g. in an integrated pulp and paper mill, and provide paper or paperboard with increased bulk. In the second embodiment of the invention, no curing is performed between the pulp treatment and the papermaking process.

“Dry” Process

Returning to FIG. 1 and the first embodiment of the present invention, in the first step i) of the process an aqueous first pulp slurry is provided. The first pulp slurry comprises cellulosic fibres and has a pulp consistency of from about 0.1 to 40 wt-%, calculated as a dry content of cellulosic fibres in the first pulp slurry. The first pulp slurry may thus be a low consistency pulp having a dry content of from 1 to 4%, medium consistency pulp having a dry content of from 8 to 12% or high consistency pulp having a dry content of from about 20 to 40%. The pulp may also have a dry content or consistency between 4 to 8% and 12 to 20%, if desired. Suitably the consistency is from 0.5 to 30%, and preferably from 1 to 20%, calculated as a dry content of cellulosic fibres in the first pulp slurry.

The raw material may be selected from any of softwood, hardwood, recycled fibres or non-wood fibres that are suitable for making paper or paperboard/cardboard or mixtures thereof. The first pulp slurry may comprise or consist of an unbleached or a bleached pulp which can comprise or consist of a chemical pulp such as a kraft (sulfate), soda or sulfite pulp. The pulp may also comprise or consist of a mechanical pulp, thermomechanical pulp (TMP), semi-chemical pulp (e.g., neutral sulfite semi-chemical pulp; NSSC), recycled pulp or chemi-thermomechanical pulp (CTMP). The pulp may consist of one type of pulp or the pulp may comprise two or more pulps as a mixture. Preferably, the cellulosic fibres originate from a chemical pulping process, which provides high quality pulps. Suitably, the fibres are derived from a kraft pulping process.

The next step ii) of treating the first pulp slurry can be performed in two alternative ways. According to a first alternative, the pH of the pulp slurry is adjusted to an acidic range, i.e. to a pH value of from 1.5 to 4.5. The pH adjustment can be performed by using any suitable acid, preferably an inorganic acid such as sulphuric acid. According to a second alternative in the step ii) the first pulp slurry is treated with a metal salt containing divalent metal ions (cations). The total metal ion concentration in the first pulp slurry is adjusted to a total concentration of from 0.0001 to 0.05 M in the first pulp slurry, preferably from 0.0005 to 0.05. The divalent metal salt may comprise a metal ion selected Zn²⁺, Mg²⁺ or Ca²⁺, or combinations thereof.

In the following step iii) an anionic or amphoteric carboxymethyl cellulose (CMC) or a derivative thereof is attached to the cellulosic fibres in the first pulp slurry. The CMC can be attached to the cellulosic fibres by treating the pulp with CMC at a temperature of at least 50° C. and in the specific conditions created during the alternative steps ii), i.e. at acidic conditions or in the presence of electrolytes, i.e. in the presence of divalent metal ions. Method for the CMC attachment is known in the prior art and can be performed as described for example in one of the applicant's previous patents, EP1240389B1.

In the following step iv) a metal salt comprising a multivalent metal ion selected from Al³⁺, Zn²⁺, Mg²⁺, Ca²⁺ or mixtures thereof, is added to the first pulp slurry. The metal ion added to a total molar concentration of the metals ion in the first slurry of from 0.0001 M to 0.5 M. If the concentration of the divalent metal ions added in the step ii) is within the desired range, no further addition of a metal salt is necessary. By adding the multivalent metal salt to the first pulp slurry, which is never-dried, it is possible to provide a bulking structure for a cured pulp product. The cured pulp product is obtained in the following curing step under acidic conditions whereby the structure of the fibres is stabilized and thus a paper or paperboard product with higher bulk can be provided. Therefore, it is possible to obtain low density paper or paperboard materials.

The counter ion in the multivalent metal salt may be any suitable counter ion and can be for example selected from Cl⁻, NO₃⁻ or SO₄²⁻ or any other suitable counter-ion, which is dissociated from the multivalent metal ion in water. Such salts are also often used in papermaking and are suitable for the processes thereof.

Preferably, the amount of the added metal salt in step iv) is kept as low as possible so that the quality of the pulp material is not degraded. Thus, the multivalent metal salt comprising a metal ion is preferably added to the pulp to a molar concentration of from 0.0001-0.05 M. Preferably, the multivalent metal salt is an aluminium salt and is added to the first pulp slurry in addition to the divalent metal ions and to a total molar concentration of from 0.0001 M to 0.05 M.

The pH of the first pulp slurry is adjusted after or before the addition of the metal salt comprising the metal ion if necessary as described in the step v) of the process. It is essential that the pH is acidic during curing and the pH of the first pulp slurry should be from pH 3.5 to pH 6.0. The adjustment can be performed by using an acid or base other than the metal salt used in steps ii) and/or iv), e.g. by using sulphuric acid.

After the addition of the multivalent metal ions and the adjustment of the pH in step v) if needed, the first pulp slurry is dewatered and cured under acidic conditions in the step vi) of the process to provide a cured web, which is to be distinguished from a dried web obtained from the final paper/paperboard process. The acidic condition during the curing in the step vi) of the first pulp slurry further increases the bulk of a paper, paperboard, tissue paper, filter paper, or fluff pulp made from the cured pulp product. This is caused by an increased hornification of the cellulosic fibres when cured under acidic conditions and especially good results have been obtained in the presence of Al³⁺ ions. This means that the fibres become stiffer in aqueous suspensions than non-treated fibres. The curing temperature is at least 60° C., and the first pulp slurry is cured until the moisture content is below 50%. Preferably, the moisture content is below 30%, and most preferably below 15%. Normally, the pulp is cured until a moisture content level of from 0 to 5% is obtained. Due to practical reasons, the pulp often contains small amounts of moisture.

It has also been noted that the curing temperature influences the bulk of the cured pulp product, i.e. a lower density may be obtained by increasing the curing temperature. Therefore, according to an embodiment of the invention, the curing temperature of the first pulp slurry can be from about 60° C. and up to about 150° C., preferably from 80 to 120° C., when the curing is performed by means of heated air/steam or by means of steam heated drying cylinders. Suitably, the first pulp slurry is cured for less than about 3 hours at the specific temperature. The cured pulp product continues to cure when it is rolled into a web roll or when stacked into bales of sheets, since the temperature of the cured pulp product decreases slowly, and this curing time is also included in the curing period of less than about 3 hours.

Alternatively or additionally to the drying by means of heated air or steam or steam heated cylinders, the first pulp slurry can be cured by means of flash drying, also called swirl fluidising. Such driers are known in the art and provided e.g. by the company GEA Process Engineering A/S or Andritz AG. By using flash drying, the drying temperature can be higher than when drying by means of heated cylinders, and the temperature can be of from 100 to 300° C., depending on the sensitivity of the first pulp slurry to the curing conditions. Also the curing time can be shorter when flash drying is used. By flash drying a further bulking effect, i.e. a higher bulk with lower density, may be obtained, and a free-flowing material may be obtained. Further, the bulk of the first pulp product may be further increased.

Thus, in the “dry process” the first pulp slurry containing the multivalent metal salt is cured before re-slushing it in a paper- or paperboard making process. It is thus possible to lower the water retention value significantly during the paper or paperboard production. The pressing efficiency can be improved significantly and a higher dry content after the press section can be obtained and therefore less energy for drying is needed. The treatment suitably takes place in a pulp mill, and the pulp is used in a non-integrated paper/board mill, and therefore the resource efficiency will be much higher both in terms of material and energy efficiency at the non-integrated paper/paperboard mill.

The cured web obtained in the step vi) can be used as such or e.g. rolled into a web roll having a pre-determined web length. Optionally, in a step vii) the cured web of pulp can be cut into sheets and the sheets are stacked to provide bales of pulp.

The cured pulp product may be used for the production of paper or paperboard, but may also be used for the production of tissue paper, filter paper, or fluff pulp.

In case of a non-integrated paper mill, it is possible to transport the cured pulp product to the paper mill from the pulp mill in the form of bales, rolls or flakes. The cured pulp product is then re-slushed in a headbox of a papermaking machine.

According to a further aspect, the present invention also relates to a process for the production of paper or paperboard. After collecting the cured web in a suitable manner in the step vi) or vii) described above, the cured web is provided to the papermaking process in a process step a). The providing is illustrated by two broken lines between the process steps i) to vi) or vii) and the process steps a) to d) in FIG. 1.

The cured pulp product is then subjected to re-slushing in step b) to provide a second pulp slurry. The second slurry is then dewatered in the step c) and a web of paper or paperboard is provided. The web is then dried in a step d) and thus a dried, bulky web of paper or paperboard that is suitable for use as a packaging material is obtained. The paper or papermaking process can be performed in a traditional way, and dry contents, additives and other papermaking process parameters known in the art can be used.

Since the cellulosic fibres become stiffer due to the treatment in steps i)-vii) above in aqueous suspensions after re-slushing, the fibres swell less during the re-slushing of the cured pulp product. This leads to webs that are easily dewatered during the papermaking process. This is a huge advantage and makes the process energy efficient while higher bulk can be obtained.

In the paper or paperboard material comprising the bulking fibres treated with a multivalent metal ion there may be a risk that the mechanical properties (e.g. z-strength for instance measured according to SCAN-P 80:98) are weakened. Thus, in order to enhance the strength of paper/board made from bulking fibres, there are several different groups of suitable dry strength aids including, but not limited to, nanocellulosic materials, such as microfibrillar cellulose, cellulose nanofibrils, cellulose filaments, nanocrystalline cellulose, fines and fines enriched pulps, starch and gum derivatives, synthetic copolymers with acrylamide, such as acrylic acid, vinyl pyridine, 2-aminoethyl methacrylate, diallyl-dimethyl ammonium chloride, dimethyl-amino-propylacryl amide, diamine ethyl acrylate, styrene and glyoxalated polyacrylamides. The latter group is also suitably copolymerized with cationic monomers. Wet strength resins such as urea-formaldehyde resins, melamine-formaldehyde resins or polyamide-polyamine-epichlorohydrine resins are also useful in order to enhance the dry strength of bulking fibres. Such dry strength aids or wet strength resins are suitably added to the second pulp slurry during paper or paperboard production, whereby the strength of the final paper or paperboard product can be improved.

“Wet Process”

A second embodiment of the present invention is illustrated in FIG. 2. This process relates to a process for the production of paper or paperboard suitable for use as a packaging board and is also called a “wet process”, since the curing step (vi) of the first embodiment is not performed. The steps I, II and III in the process are similar to the process steps i) to iii) in FIG. 1 and reference is made to the description above in connection with FIG. 1. In short, the steps I to III comprise:
I. providing a first aqueous pulp slurry comprising cellulosic fibres and having a pulp consistency of from 0.1 to 40% by weight, calculated as dry weight of the cellulosic fibres in the first pulp slurry;
II. adjusting the pH of the first pulp slurry to a range from pH 1.5 to pH 4.5, or alternatively treating the first pulp slurry with a metal salt containing divalent metal ions selected from Zn²⁺, Mg²⁺, Ca²⁺ or mixtures thereof, to a total molar concentration of the metal salt of from 0.0001-0.5 M in the first pulp slurry
III. attaching an anionic or amphoteric carboxymethyl cellulose (CMC) or a derivative thereof to the cellulosic fibres in the first pulp slurry by treating the first pulp slurry with the CMC at a temperature of at least 50° C.;

After the steps I to III, in the following step IV, the cellulosic fibres with the attached CMC in the first pulp slurry is ion-exchanged to counter-ions with high valency. This means that a multivalent metal salt comprising aluminium Al³⁺-metal ion is added to the first pulp slurry to a total molar concentration from 0.0001 M to 0.5 M, whereby an ion-exchange occurs. Without binding to any specific theory, it is believed that when the ion-exchange occurs, the fibre to fibre friction increases significantly in the presence of Al³⁺-ions on the surface of the fibres. The higher friction between the fibres in the wet state will partly prevent sheet consolidation and result in a paper/paperboard product with a higher bulk. It is also believed that the fibres thus form a network of fibres and this network can be maintained during a drying process in a papermaking process.

After the addition of the aluminium salt, the first pulp slurry is provided to a papermaking process in step V. The paper making process may be of any known kind and chemicals and other papermaking parameters suitable for the process in question can be used. In a usual manner, the first pulp slurry is then dewatered in step VI) to provide a web and finally, in the step VII) the web is dried to provide a web of paper or paperboard.

In a similar manner as mentioned above, the process may further comprise adding a dry strength aid or a wet strength resin to the first pulp slurry. The same aids or resins as mentioned above can be used for the purpose.

The present invention also relates to a paper or paperboard product suitable for use as a packaging material which is obtained by the processes described above. It is possible to obtain a high quality paper or paperboard with low density having a structural density according to SCAN-P-88:01 of from 150 to 600 kg/m³. The paper or paperboard product is suitably used as a packaging material. Preferably, the paper or paperboard product can be used as a middle layer in a paperboard to provide increased bulk for the paperboard product.

The present process is suitable for use in both pulping and papermaking mills/factories that are integrated or non-integrated, since the curing step after metal-ion addition is not essential for the bulking effect in the second embodiment of the invention.

The invention will now be further described and illustrated in the following examples.

### EXAMPLES

The following exampled illustrate the effects of the present invention, but should not be regarded as limiting the scope of invention in any way.

### Example 1

A never-dried bleached softwood kraft pulp was treated with 20 and 40 mg/g amphoteric CMC having degree of substitution of anionic groups=0.48 and degree of substitution of cationic groups=0.027, whereby the amphoteric CMC has a total net anionic charge, whereby the amount of carboxylic groups on the surface of fibres can be enhanced. The pulps were treated with the CMC under conditions given in Table 1 below.

TABLE 1
CMC Grafting conditions.

| | |
|---|---|
| Water type | Deionised water |
| Pulp concentration | 25 g/litre (2.5% by weight) |
| Electrolyte concentration (CaCl₂) | 0.05M |
| CMC addition | 20 mg CMC/g fibre, or |
| | 40 mg CMC/g fibre |
| pH | 8 |
| Temperature during CMC | 120° C. |
| treatment | |
| Time for CMC treatment | 2 hrs |

The amount of attached CMC was quantitative, i.e. all CMC became attached to the fibre surface. After the CMC-attachment, the pulp was treated with AlCl₃ to a total molar concentration of 0.005 M AlCl₃ and the pH was adjusted to 4.0 and 5.0, respectively. After the pH adjustment, the pulp was dewatered on a Buchner funnel to a solids content of around 20%. The pulp was then cured at 120° C. for 2 h (oven drying), after which the pulp was re-slushed and formed into sheets in accordance with ISO 5269-1:2005, except that the sheets were pressed at 400 kPa for 5 min.

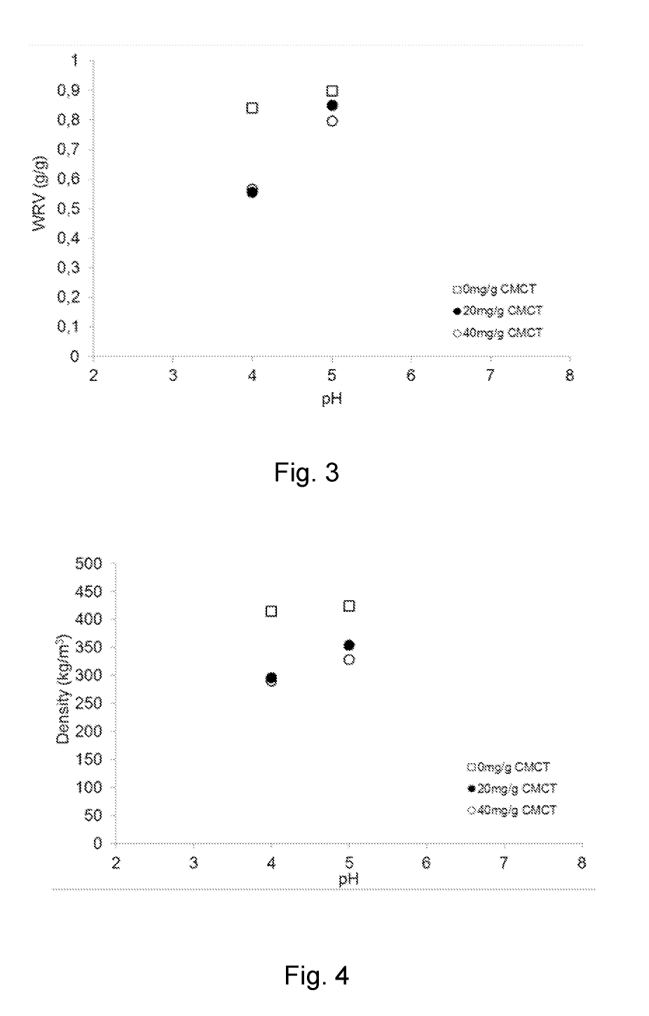

The water retention value (WRV) was measured according to SCAN-C62:00 before the sheet forming. The structural density (SCAN-P 88:01) was then determined on the prepared and pressed sheets. The effects on the WRV and resulting sheet density obtained by the process, also referred to as a “dry process” are shown in FIG. 3 and FIG. 4 respectively. In the process amphoteric CMC is attached to the cellulosic fibres in an amount of 20 mg/g and 40 mg/g.

From FIG. 3 it can be concluded that if the CMC is attached to the cellulosic fibres and the fibres are transferred to their aluminium form and dried under acidic conditions, the water retention value can be lowered and thus improved. It can also be concluded that the WRV decreases and thus improves when the pH decreases. Thus, the lower the pH value is, the lower the obtained WRV is.

From FIG. 4 it can be concluded that if the CMC is attached to the cellulosic fibres and the fibres are transferred to their aluminium form and dried under acidic conditions a higher bulk of the sheets is obtained compared to pulps not treated with CMC. It can also be concluded that the density decreases leading to improved bulk when the pH decreases.

### Example 2

This example shows the effects of different treatment temperatures and times on WRV, which are believed to occur due to hornification.

Never-dried bleached softwood kraft pulp was treated with 20 mg/g amphoteric CMC having a degree of substitution of anionic groups=0.48 and degree of substitution of cationic groups=0.027, wherein the CMC has a net anionic charge, whereby the amount of carboxylic groups on the surface of fibres can be enhanced. The pulps were treated with the CMC under conditions given in Table 1 above and in Example 1. The fibres were then transferred to their aluminium form and cured at different temperatures, 60° C., 80° C., and 120° C. After the curing the pulps were re-slushed and their WRV values according to SCAN-C62:00 were determined.

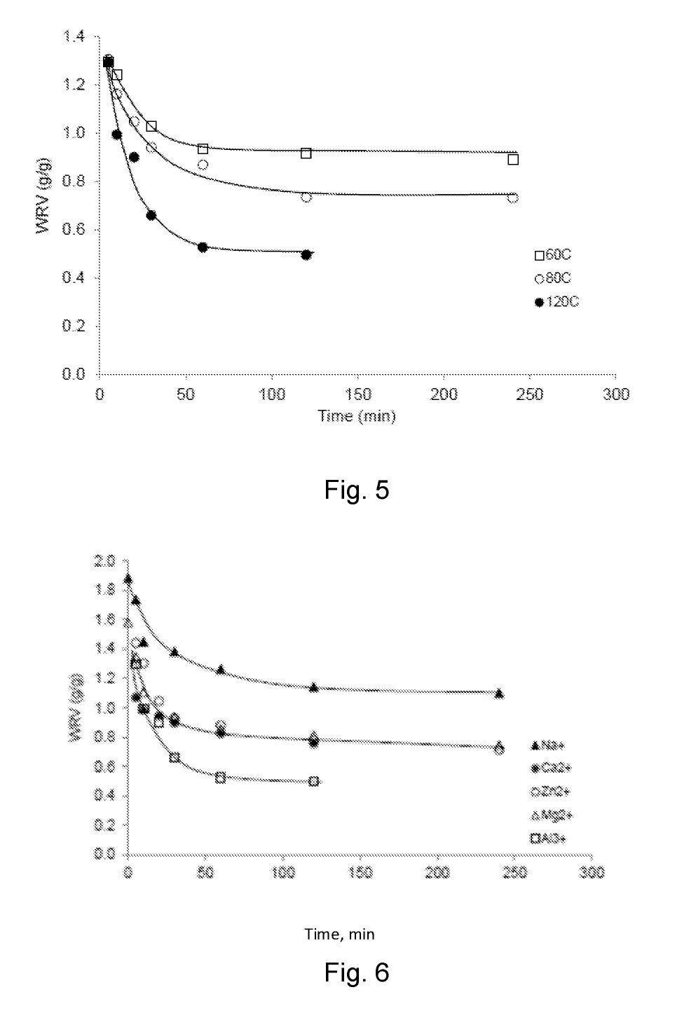

FIG. 5 shows in a graph the effect of the curing (oven curing) temperature on WRV due to hornification of a pulp treated with 20 mg/g amphoteric CMC pulp in its Al-form (i.e. a total molar concentration of Al-ions 0.005 M) and pH 3.5.

It can be concluded that the higher the curing temperature is, the more the WRV decreases and thus improves the bulk of the paper/board.

### Example 3

A never-dried bleached softwood kraft pulp was treated with 20 mg/g amphoteric CMC having a degree of substitution of anionic groups=0.48 and a degree of substitution of cationic groups=0.027, and thus having a net anionic charge, whereby the amount of carboxylic groups on the surface of fibres can be enhanced. The treatment was performed under the conditions given in Table 1 above and Example 1. After the treatment the pulps were brought in contact with different metal ion salts (i.e. electrolytes; as chloride salts) for 20 min at a total molar concentration of the salts in the pulp slurry as follows:

Na⁺: 0.005 M;

Ca²⁺: 0.005 M

Mg²⁺: 0.005 M

Zn²⁺: 0.005 M

Al³⁺: 0.005 M

The pulps were then cured at 120° C. for various times and re-slushed, after which the WRV was determined. The results are shown in FIG. 6.

It can be concluded that when the valency of the metal ion increases, the WRV decreases and thus improves the bulk of the paper/board. Therefore, e.g. much lower WRV values were obtained with Al³⁺ metal ions than with Na⁺ metal ions.

### Example 4

This example illustrates that it is not always necessary to cure the pulp in order to enhance the bulk of formed sheets and that bulk can also be obtained by the treatment according to the “wet process” as described above. It is possible to attach CMC (anionic) or amphoteric CMC, whereby the amount of carboxylic groups on the surface of fibres can be enhanced. Hence, a pulp slurry of unbeaten bleached softwood kraft pulp was treated with 20 mg/g fibre of anionic CMC (degree of substitution=0.4, Aquasorb A-500, Hercules, Sweden) under the same conditions as shown in table 1 above in connection with Example 1.

Before the attachment of the CMC the pulp was set to its calcium form. The pulp was given an acidic treatment at pH 2, after which the pulp was washed with deionized water and the pH was increased to pH 8, again washed with deionized water and treated with a 10⁻²M CaCl₂ solution and then finally washed with deionized water.

The pulp was then mixed with the CMC solution and with CaCl₂. The pH was adjusted to 8 using NaOH. The mixture was then inserted in an autoclave. The autoclave was heated up under constant agitation in a glycol bath which had a constant temperature of 120° C. After the two hour long attachment process, the pulp was washed with deionised water on a Buchner funnel until the conductivity in the filtrate was below 5 μS/cm.

The results from the treatment are shown in Table 2. The total amount of the attached CMC was calculated from the total charge density increase to be 20.6 mg/g (+/−1 mg/g), that is, the attachment efficiency can be considered as quantitative. The surface selectivity of the attachment, i.e. the amount of charges accessible on the surface of fibres as determined by polyelectrolyte titration using high molecular weight poly-DADMAC (poly-DiallylDiMethyl-AmmoniumChloride was found to be 87.7%, i.e. most of the CMC was being attached onto the surface of the fibres. As reference an untreated pulp washed to its Ca²⁺ form was used. The method has been described by Horvath A E, Lindstrom T and Laine J. Langmuir, 22(2) (2006), 824-830.

TABLE 2
Total and surface charge of reference pulp and
pulp with attached CMC (20 mg/g) pulp.

| | Total | Surface | |
|---|---|---|---|
| | Charge | Charge | Charge ratio |
| Pulp | (eqv./g) | (eqv./g) | (surface/total) |
| Reference pulp | 39.5 | 1.6 | 0.04 |
| (Untreated pulp | | | |
| washed to its Ca²⁺ | | | |
| form) | | | |
| CMC grafted pulp | 83.6 | 37.2 | 0.44 |

The pulp treated with CMC 20 mg/g fibre was transferred to its Na⁺, Ca²⁺ and Al³⁺-form, respectively. Different structural densities were obtained by forming sheets in accordance with ISO 5269-1:2005, except that different pressing levels were used. Each sheet was pressed for 5 minutes with different pressing levels, respectively (50, 100, 200, 400, 600, and 800 kPa).

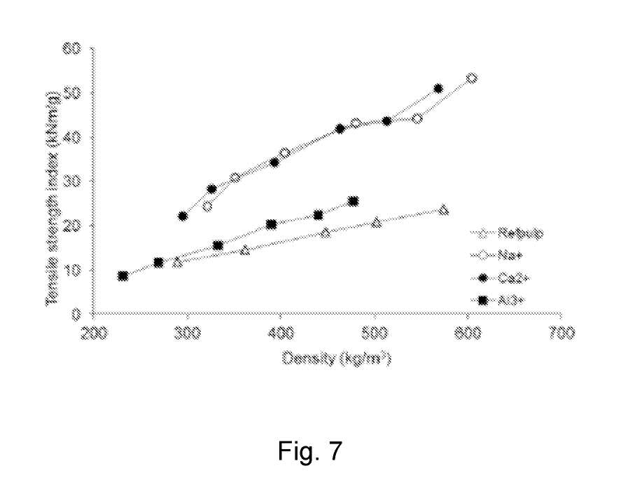

FIG. 7 shows a tensile strength index (ISO 1924-3: 2005) versus structural density of paper sheets pressed to different densities. The pulps were grafted with 20 mg/g CMC and then transferred to different ionic forms (Na⁺, Ca²⁺, Al³⁺) together with a reference pulp without any attached CMC in its Ca²⁺-form.

FIG. 7 shows how the tensile strength index of reference sheets and sheets (ISO 5269-1:2005) made from the bleached kraft pulp with the attached CMC is affected by the ionic form of the pulp. Apart from the strength development, the sheets in their Na⁺-form and Ca²⁺-form have approximately the same sheet density irrespective of pressing pressure, whereas the sheets in their aluminium form have significantly lower sheet density. This example shows that it is possible to make bulky sheets without curing before forming sheets by transferring paper sheets with attached CMC to their Al³⁺-form before drying. However, curing of the pulp to induce hornification is not a requirement, but stronger bulking effect can be achieved by the “dry procedure”.

It is clear to the skilled person in the art that the invention may be varied within the scope of the appended claims. The examples and embodiments above are not intended to limit the scope of the invention in any way. Instead the invention may be varied within the scope of the appended claims.

1. A process for the production of a cured pulp product suitable for use in the production of paper, paperboard, tissue paper, filter paper or fluff pulp, comprising the steps of:
i) providing a first aqueous pulp slurry comprising cellulosic fibres and having a pulp consistency of from 0.1 to 40% by weight, calculated as dry weight of the cellulosic fibres in the first pulp slurry;
ii) adjusting the pH of the first pulp slurry to a pH of from 1.5 to 4.5, or alternatively treating the first pulp slurry with a metal salt containing divalent metal ions selected from Zn²⁺, Mg²⁺, Ca²⁺ or mixtures thereof, to a total molar metal ion concentration of from 0.0001 to 0.5 M in the first pulp slurry;
iii) attaching an anionic or an amphoteric carboxymethyl cellulose (CMC) or a derivative thereof to the cellulosic fibres in the first pulp slurry by treating the pulp slurry with the CMC at a temperature of at least 50° C.;
iv) adding to the first pulp slurry a metal salt comprising Al³⁺ ions at a total molar metal ion concentration of from 0.0001M to 0.5 M in the first pulp slurry, or alternatively controlling the concentration of the divalent metal ions in the pulp slurry and adjusting the total molar concentration of the divalent metal ions selected from Zn²⁺, Mg²⁺, Ca²⁺ or mixtures thereof to a range of from 0.0001 M to 0.5 M in the first pulp slurry, if the total molar concentration is not within the range of from 0.0001 M to 0.5 M in the first pulp slurry;
v) controlling the pH and adjusting the pH of the first pulp slurry to a pH of from pH 3.0 to pH 6.0 if the pH is not within the range of from pH 3.0 to pH 6.0; and
vi) dewatering and curing the first pulp slurry at a temperature of at least 60° C. and thus provide a cured pulp product.

2. The process according to claim 1, wherein in the step vi) the first pulp slurry is cured by means of flash drying at a temperature of from 100° C. to 300° C., preferably from 150° C. to 270° C. and most preferably from 180° C. to 240° C.

3. The process according to claim 2, wherein the curing time is less than 5 minutes, preferably less than one minute.

4. The process according to claim 1, wherein in the step vi) the first pulp slurry is cured at a temperature of from 60 to 150° C. by means of heated air or steam.

5. The process according to claim 4, wherein in the step vi) the cured pulp product is provided in the form of a cured web.

6. The process according to claim 5, wherein the process further comprises a step vii) comprising cutting the cured web of pulp into sheets and stacking the sheets to bales of pulp.

7. The process according to claim 1, wherein in the step vi) the cured pulp product is cured until a moisture content of below 50%, preferably below 30% and most preferably below 15%, based on the total weight of the cured pulp product, is obtained.

8. The process according to claim 1, wherein in the step iv) the metal salt is a metal salt containing Al³⁺ ions which is added to the first pulp slurry to a total molar concentration of from 0.0001 M to 0.05 M in the first pulp slurry.

9. The process according to claim 1, wherein the pulp consistency of the first aqueous pulp slurry is of from 0.5% to 30%, preferably of from 1% to 20%, calculated as dry weight of the cellulosic fibres in the first pulp slurry.

10. The process according to claim 1, wherein the CMC is amphoteric and has a cationic molar substitution degree of from 0.00001 to 0.4 and an anionic molar substitution degree of from 0.3 to 1.2, and wherein a net charge of the CMC is anionic.

11. The process according to claim 1, wherein the CMC is anionic and has an anionic molar substitution degree of from 0.3 to 1.2.

12. The process according to claim 1, wherein the amount of the anionic or amphoteric CMC attached during the treatment is of from 1 to 100 mg/g, based on the weight of the cellulosic fibres in the first pulp slurry.

13. The process according to claim 1, wherein the first aqueous pulp slurry comprises a pulp selected from a kraft, soda, sulfite, mechanical, thermomechanical, semi-chemical or chemi-thermomechanical pulp, recycled pulp or mixtures thereof.

14. A cured pulp product obtained according to the process of claim 1.

15. A process for the production of paper or paperboard comprising the steps of:
a. providing a cured pulp product according to claim 14 to a paper making process;
b. re-slushing the cured pulp product to provide an aqueous second pulp slurry;
c. dewatering the aqueous second pulp slurry to provide a web of paper or paperboard; and
d. drying the web of paper or paperboard to provide a dried web of paper or paperboard.

16. (canceled)

17. A process for the production of paper or paperboard comprising the steps of:
I. providing a first aqueous pulp slurry comprising cellulosic fibres and having a pulp consistency of from 0.1 to 40% by weight, calculated as dry weight of the cellulosic fibres in the first pulp slurry;
II. adjusting the pH of the first pulp slurry to a pH of from 1.5 to 4.5, or alternatively treating the first pulp slurry with a metal salt containing divalent metal ions selected from Zn²⁺, Mg²⁺, Ca²⁺ or mixtures thereof, to a total molar concentration of the metal ions of from 0.0001 to 0.5 M in the first pulp slurry;
III. attaching an anionic or amphoteric carboxymethyl cellulose (CMC) or a derivative thereof to the cellulosic fibres in the first pulp slurry by treating the first pulp slurry with the CMC at a temperature of at least 50° C.;
IV. adding to the first pulp slurry a metal salt comprising an Al³⁺ metal ion to a total metal ion molar concentration of from 0.0001 M to 0.5 M in the first pulp slurry whereby an ion-exchange occurs;
V. providing the first pulp slurry to a papermaking process and thus provide a second pulp slurry;
VI. dewatering the second pulp slurry to provide a web of paper or paperboard; and
VII. drying the web of paper or paperboard to provide a dried web of paper or paperboard.

18. The process according to claim 17, wherein the first pulp slurry comprises a pulp selected from a kraft, soda, sulfite, mechanical, thermomechanical, semi-chemical or chemi-thermomechanical pulp, or mixtures thereof.

19. (canceled)

20. The process according to claim 17, wherein the CMC is amphoteric and has a cationic molar substitution degree of from 0.00001 to 0.4 and an anionic molar substitution degree of from 0.3 to 1.2.

21. The process according to claim 17, wherein the CMC is anionic and has an anionic molar substitution degree of from 0.3 to 1.2.

22. The process according to claim 17, wherein the amount of the anionic or amphoteric CMC attached during the treatment is of from 1 to 100 mg/g, based on the weight of the cellulosic fibres in the first pulp slurry.

23-31. (canceled)
